(19) United States
(12) Patent Application Publication
(10) Pub. No.: US 2004/0163068 A1
(43) Pub. Date: Aug. 19, 2004

(54) Logic circuit diagram input device

(75) Inventors: Eiichi Fukita, Tokyo (JP); Minoru Ikeda, Tokyo (JP)

Correspondence Address: McDERMOTT, WILL & EMERY, 600 13th Street, N.W., Washington, DC, 20005-3096, US

(73) Assignee: RENESAS TECHNOLOGY CORP.

(21) Appl. No.: 10/671,467

(22) Filed: Sep. 29, 2003

(30) Foreign Application Priority Data
Feb. 19, 2003 (JP) 2003-40701

(51) Int. Cl. G06F 9/455; G06F 17/50

(52) U.S. Cl. 716/11

(57) ABSTRACT

It was difficult to precisely estimate a layout area of a logic circuit diagram from the logic circuit diagram.

Then, in order to estimate the layout area from the logic circuit diagram constituted by a transistor as a minimum unit, there is provided with hierarchy developing means for developing logic circuit diagram information having a hierarchical structure to information at a transistor level, configuration parameter information extracting means for extracting information such as a gate length, a gate width or the like of each transistor, area calculating means for calculating each transistor area using an area calculation formula for calculating a transistor area from the above information, and layout area estimating means for obtaining a layout area by adding all areas of the transistors together.

### BACKGROUND OF THE INVENTION

1. Field of the Invention

In designing a memory LSI or the like in which restriction for a chip area is severe, it is necessary to design a logic circuit in consideration of an actual layout area at the stage of designing the logic circuit before its layout. The present invention relates to a logic circuit input device having a function of estimating an actual layout area easily based on property information (referred to as configuration parameter value information hereinafter) or the like which represents a configuration added to an instance of a transistor (or logic gate or a micro processor) arranged in a logic circuit diagram.

2. Description of the Background Art

In designing an ASIC constituted by a synchronous circuit, it is possible to precisely estimate the actual layout area at the stage of logic designing to a certain extent by applying a logic synthesis method using a technology library (in which a delay/timing/area for each standard cell and area possession ratio of a wiring are defined). However, according to designing of a memory LSI or the like in which area restriction on a chip is severe, since the logic circuit operates in an asynchronous manner, a full custom design method by which while transistors or the like are manually input, their sizes are fine-tuned to adjust the timing, has been mainly employed.

Therefore, it is difficult to estimate the actual layout area before the logic circuit is nearly determined and even if the logic is determined, the layout area is estimated based on an experience of the designer or manually from the arranged transistors because it is constituted by a transistor. Thus, precision of the estimation is lowered. As a result, an area restriction applied at the stage of designing the layout could not be conformed and it becomes necessary to redesign the logic circuit, so that a designing schedule could be delayed in the worst case.

As this kind of circuit designing, it is known that a layout area is calculated from a outer dimension of an element each time the element is arranged and the values are added sequentially while the circuit is designed (referring to Patent Document 1, for example).

[Patent Document 1]

Japanese Unexamined Patent No. 2001-22799, “method of designing circuit and support system for circuit designing”

However, according to the Patent Document 1, the layout area is calculated while the circuit is designed. Therefore, the area of the element is simply added together (it is focused on to know whether the layout area calculated during the designing exceeds a targeted value) and the layout area obtained after the circuit is designed is only a value calculated from the kind of the transistor and the number thereof immediately. Furthermore, the degree of precision of the calculation is low because the outer dimension is simply calculated from longitudinal and transversal dimensions in the maximum bulge width.

### SUMMARY OF THE INVENTION

According to the present invention, there is provided a logic circuit diagram input device which can obtain not only areas of respective elements precisely but also a layout area according to an instance when the element is laid out and also can obtain the layout area in consideration of a wiring as well.

A logic circuit diagram input device for estimating a layout area based on a logic circuit diagram constituted by a transistor as a minimum unit includes hierarchy developing means for developing logic circuit diagram information having a hierarchical structure to information at a transistor level, configuration parameter information extracting means for extracting configuration parameter information which is added to each transistor as a property, area calculating means for calculating each transistor area using a transistor area calculation formula for calculating a transistor area from the above configuration parameter information, and layout area estimating means for estimating a layout area by adding all areas of the transistors together.

### BRIEF DESCRIPTION OF THE DRAWINGS

FIG. 1 is a block diagram showing a logic circuit diagram input device according to an embodiment 1 of the present invention;

FIG. 2 is a flowchart showing operations of the block diagram shown in FIG. 1;

FIG. 3 is a view showing an example of a logic circuit diagram having a hierarchical structure and its information;

FIG. 4 is a view showing a configuration parameter of a transistor;

FIG. 5 is a view showing a area calculation formula holding part of a transistor;

FIG. 6 is a block diagram showing a logic circuit diagram input device according to an embodiment 2 of the present invention;

FIG. 7 is a flowchart showing operations of the block diagram shown in FIG. 6;

FIG. 8 is a view showing an example of a logic circuit diagram having a hierarchical structure and its information;

FIG. 9 is a block diagram showing a logic circuit diagram input device according to an embodiment 3 of the present invention;

FIG. 10 is a flowchart showing operations of the block diagram shown in FIG. 9;

FIG. 11 is a view showing a definition example in an each standard cell area holding part;

FIG. 12 is a block diagram showing a logic circuit diagram input device according to an embodiment 4 of the present invention;

FIG. 13 is a view showing a definition example in an each standard cell area possession ratio holding part;

FIG. 14 is a flowchart showing operations of the block diagram shown in FIG. 12;

FIG. 15 is a block diagram showing a logic circuit diagram input device according to an embodiment 5 of the present invention;

FIG. 16 is a flowchart showing operations of the block diagram shown in FIG. 15;

FIG. 17 is a view showing a definition example in a probable wiring area value for each block area holding part;

FIG. 18 is a block diagram showing a logic circuit diagram input device according to an embodiment 6 of the present invention;

FIG. 19 is a flowchart showing operations of the block diagram shown in FIG. 18;

FIG. 20 is a view showing a definition example in a probable wiring capacity value for each block area holding part;

FIG. 21 is a block diagram showing a logic circuit diagram input device according to an embodiment 8 of the present invention;

FIG. 22 is a flowchart showing operations of the block diagram shown in FIG. 21;

FIG. 23 is a view showing parameters of a transistor, a resistance and a capacity;

FIG. 24 is a view showing a transistor area calculation formula holding part;

FIG. 25 is a block diagram showing a logic circuit diagram input device according to an embodiment 9 of the present invention; and

FIG. 26 is a flowchart showing operations of the block diagram shown in FIG. 25.

### DESCRIPTION OF THE PREFERRED EMBODIMENTS

Embodiment 1

According to an embodiment 1 of the present invention, a description will be made of a “logic circuit diagram input device” which can easily estimate a layout area of a “logic circuit diagram comprising a transistor as a minimum unit” based on the logic circuit diagram.

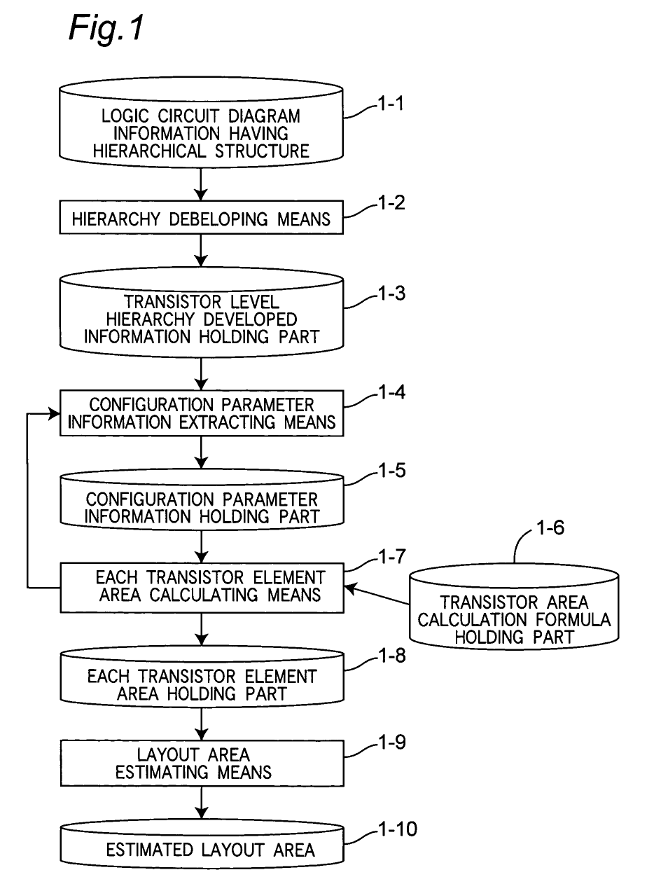

FIG. 1 is a block diagram showing a structure of the “logic circuit diagram input device” according to this embodiment 1. Referring to FIG. 1, a “logic circuit diagram information storing part having a hierarchical structure” 1-1 stores information of a logic circuit diagram having a hierarchical structure for calculating an area and the logic circuit diagram information is constituted by a transistor element as a minimum unit. Configuration parameter information is added to each transistor element as a property.

“Hierarchy developing means” 1-2 develops the information stored in the “logic circuit diagram information storing part having the hierarchical structure” 1-1 to a level of a transistor and a “transistor level hierarchy developed information holding part” 1-3 holds the transistor element information hierarchically developed by the “hierarchy developing means” 1-2. “Configuration parameter information extracting means” 1-4 extracts configuration parameter information added as a property from the transistor element information held in the “transistor level hierarchy developed information holding part” 1-3.

A “configuration parameter information holding part” 1-5 holds configuration parameter information of each transistor element, which is extracted by the “configuration parameter information extracting means” 1-4. A “transistor area calculation formula holding part” 1-6 holds an area calculation formula for one transistor. “Each transistor element area calculating means” 1-7 calculates an area of each transistor element from the configuration parameter information of each transistor element held in the “configuration parameter information holding part” 1-5 using the calculation formula defined in the “transistor area calculation formula holding part” 1-6.

An “each transistor element area holding part” 1-8 holds each transistor element area calculated by the “transistor area calculating means” 1-7. “Layout area estimating means” 1-9 calculates an estimated layout area by adding areas of the transistor elements held in the “each transistor element area holding part” 1-8 based on the logic circuit diagram information having the hierarchical structure shown in FIG. 3 and stores it in an “estimated layout area storing part” 1-10.

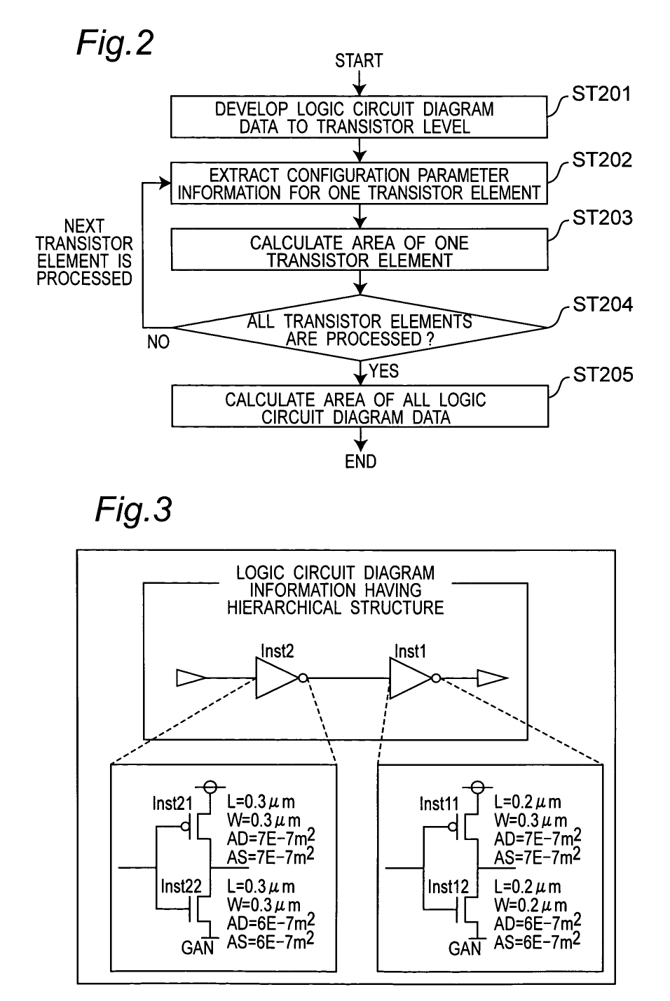

FIG. 2 is a flowchart showing operations of the above-described “logic circuit diagram input device”. The operations will be described with reference to an example shown in FIG. 3. First, logic circuit diagram information having the hierarchical structure shown in FIG. 3 is read from the “logic circuit diagram information storing part having a hierarchical structure” 1-1 and developed to the level of a transistor by the “hierarchy developing means” 1-2. Then, the developed information of each of the transistor elements Inst 11, Inst 12, Inst 21 and Inst 22 is held by the “transistor level hierarchy developed information holding part” 1-3 (step ST201).

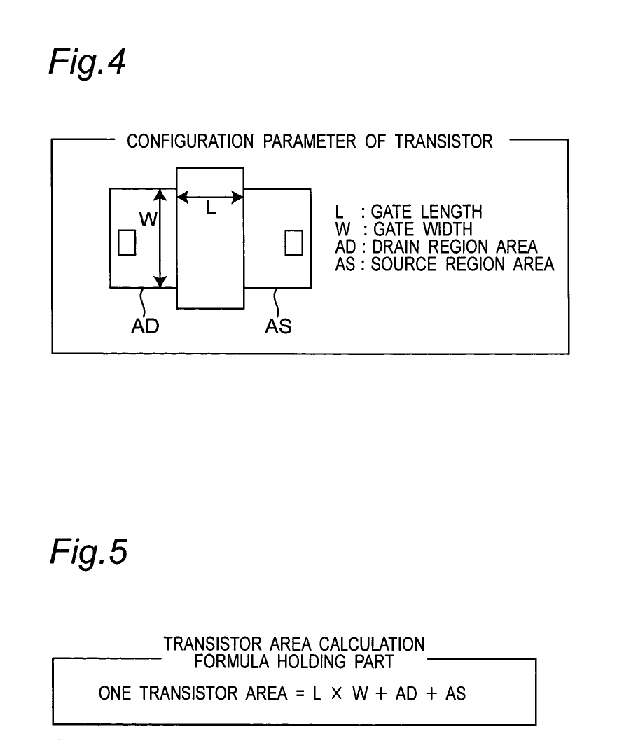

Then, the configuration parameter information which was added as a property for the Inst 11 among the transistor elements held in the “transistor level hierarchy developed information holding part” 1-3 is extracted and held in the “configuration parameter information holding part” 1-5 (step ST202). The extracted configuration parameter information includes a gate length L, a gate width W, a drain region area AD and a source region area AS shown in FIG. 4.

Then, an area of the Inst11: 20E−7 μm² is found from the configuration parameter information of the Inst 11 stored in the “configuration parameter information holding part” 1-5 using the area calculation formula for one transistor (FIG. 5):

A transistor area=L×W+AD+AS

which is stored in the “transistor area calculation formula holding part” 1-6 (ST202) and it is stored in the “each transistor element area holding part” 1-8 (step ST203). The operations at steps ST202 and ST203 are performed for all of the remaining Inst 12, Inst 21 and Inst 22 (step ST204).

At last, an estimated layout area: 8OE−7 μm² is obtained by adding the area values of the Inst 11, Inst 12, Inst 21 and Inst 22 which were stored in the “each transistor element area holding part” 1-8 at steps ST202 to ST204(ST205).

Thus, since the layout area can be easily and precisely estimated at the stage of designing the logic circuit, it is eliminated to be forced to change the design of the logic circuit because of an area restriction violation which is generated often at the time of the layout designing.

Embodiment 2

According to an embodiment 2 of the present invention, a description will be made of a “logic circuit diagram input device” which can further precisely estimate the layout area of a logic circuit diagram based on the “logic circuit diagram constituted by a transistor as a minimum unit” by correcting each transistor area calculated in the embodiment 1 with a predefined “area possession ratio” for each transistor element.

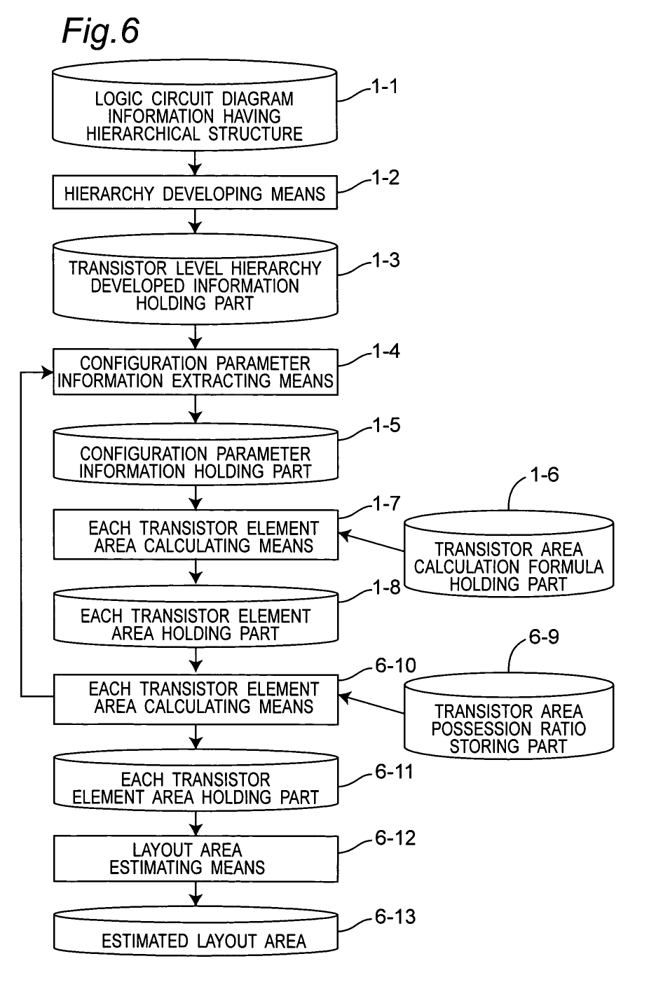

FIG. 6 is a block diagram showing a structure of the “logic circuit diagram input device” according to the embodiment 2 of the present invention. Referring to FIG. 6, blocks 1-1 to 1-8 are the same ones as those to which the same reference numerals are allotted in FIG. 1 in the embodiment 1. A“transistor area possession ratio storing part” 6-9 stores an area possession ratio which is defined for the transistor. In addition, a given value can be input for the area possession ratio of the transistor from an outer input device by a user of this device.

“Each transistor element area calculating means” 6-10 divides each area of the transistor elements held in the “each transistor element area holding part” 1-8 by the possession ratio which was defined in the “transistor area possession ratio holding part” 6-9 and finds each possession area of the transistor element on a layout. An “each transistor element area holding part” 6-11 holds the layout area of the transistor element which was obtained by the “each transistor element area calculating means” 6-10. According to this embodiment, the area possession ratio of the transistor held in the “transistor area possession ratio holding part” 6-9 is set at 0.5.

“Layout area estimating means” 6-12 finds the estimated layout area by adding respective possession areas of the transistor elements held in the “each transistor element layout possession area holding part” 6-11 and stores in an “estimated layout area storing means” 6-13.

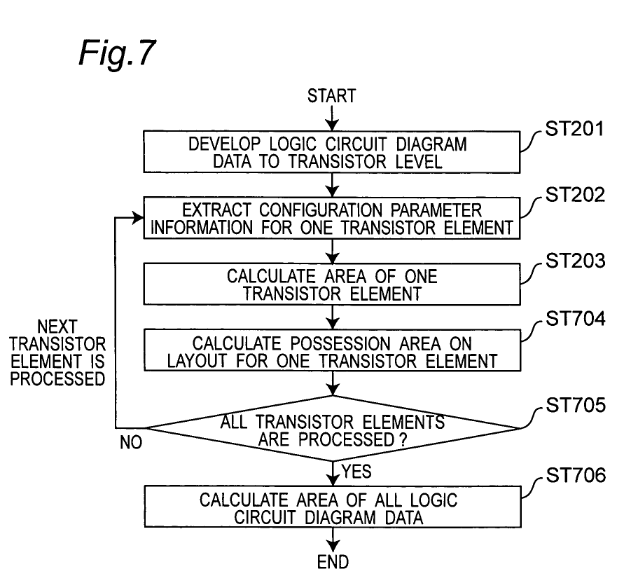

FIG. 7 is a flowchart showing operations of the above-described “logic circuit diagram input device” and the operations will be described with reference to the example shown in FIG. 3. First, at steps ST201 to ST203 in FIG. 7, the same operations as the steps ST201 to ST203 described in FIG. 2 according to the embodiment 1 are performed to obtain the area of the Inst 11: 20E−8 μm² and stored it in the “each transistor element area holding part” 1-8.

Then, the area of the Inst 11: 20E−8 μm²stored in the “each transistor element area holding part” 1-8 is divided by the possession ratio 0.5 defined in the “transistor area possession ratio holding part” 6-9 to obtain the area of the Inst 11: 20E−8 μm² and stores it in the “each transistor element area holding part” 6-11 (step ST704). The operations at steps ST202 to ST704 are performed on all of the remaining transistor elements Inst 12, Inst 21 and Inst 22 (step ST705).

At last, an estimated layout area: 160E−8 μm²is obtained by adding the possession area values on the layout of the respective Inst 11, Inst 12, Inst 21 and Inst 22 which were stored in the “each transistor element area holding part” 6-11 at steps ST202 to ST705 (ST706).

Thus, since the calculated area for each transistor is corrected with the area possession ratio of the transistor, the area after laid out is further precisely and easily estimated as compared with the embodiment 1 of the present invention and it can be eliminated to be forced to change the design of the logic circuit because of area restriction violation which is often generated at the time of the layout designing.

Embodiment 3

According to an embodiment 3 of the present invention, a description will be made of a “logic circuit diagram input device” which can easily estimate a layout area of a “logic circuit diagram constituted by a standard cell” based on the logic circuit diagram “in view of an arrangement condition of the cells” additionally.

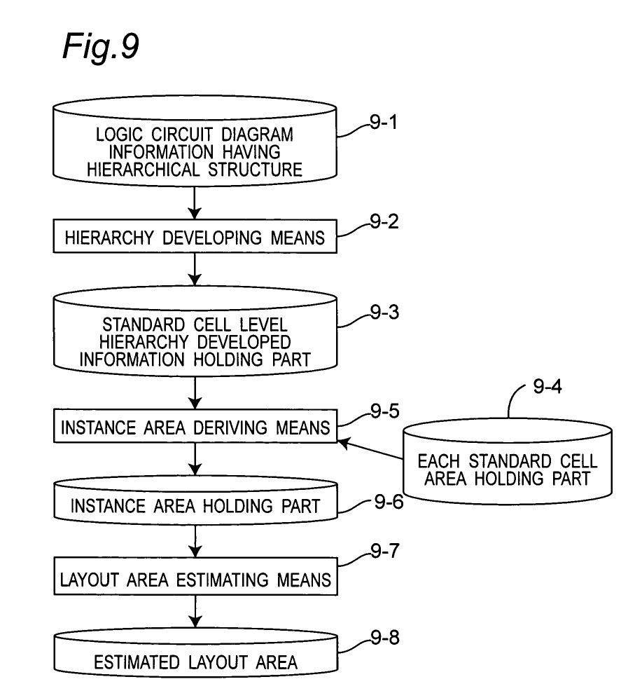

FIG. 9 is a block diagram showing a structure of the “logic circuit diagram input device” according to the embodiment 3. Referring to FIG. 9, a “logic circuit diagram information storing part having a hierarchical structure” 9-1 stores the information for calculating the area and this information comprises a standard cell as a minimum unit. The standard cell means having one function at a gate level like an inverter or NAND.

“Hierarchy developing means” 9-2 develops the logic circuit diagram information stored in the “logic circuit diagram information storing part having a hierarchical structure” 9-1 to a level of the standard cell and a “standard cell level hierarchy-developed information holding part” 9-3 holds the information of the standard cell elements which was developed by the “hierarchy developing means” 9-2. The element information includes instances indicating arrangement conditions of the cells (arrangement density or a relation between cells). An “each standard cell area holding part” 9-4 holds the area for each standard cell according to the instance. “Instance area deriving means” 9-5 extracts an area value corresponding to the instance of the relevant cell from the “each standard cell area holding part” 9-4 and allots it to each of the standard cells held in the “standard cell level hierarchy-developed information holding part” 9-3.

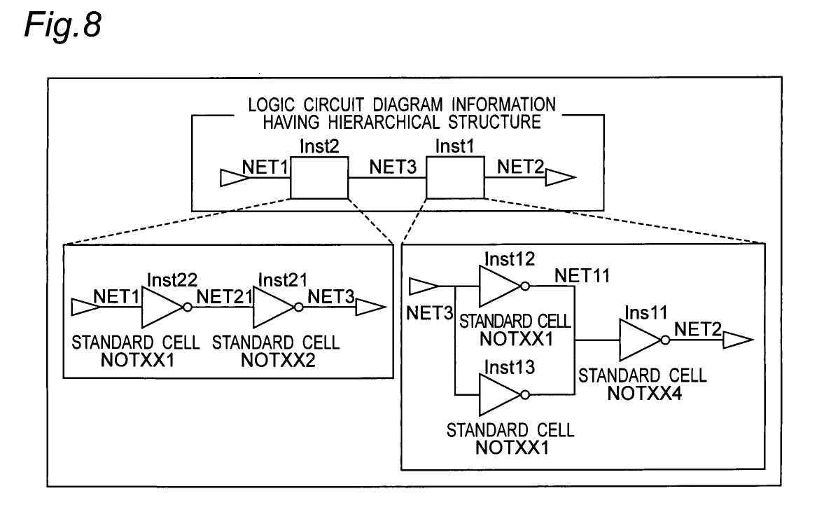

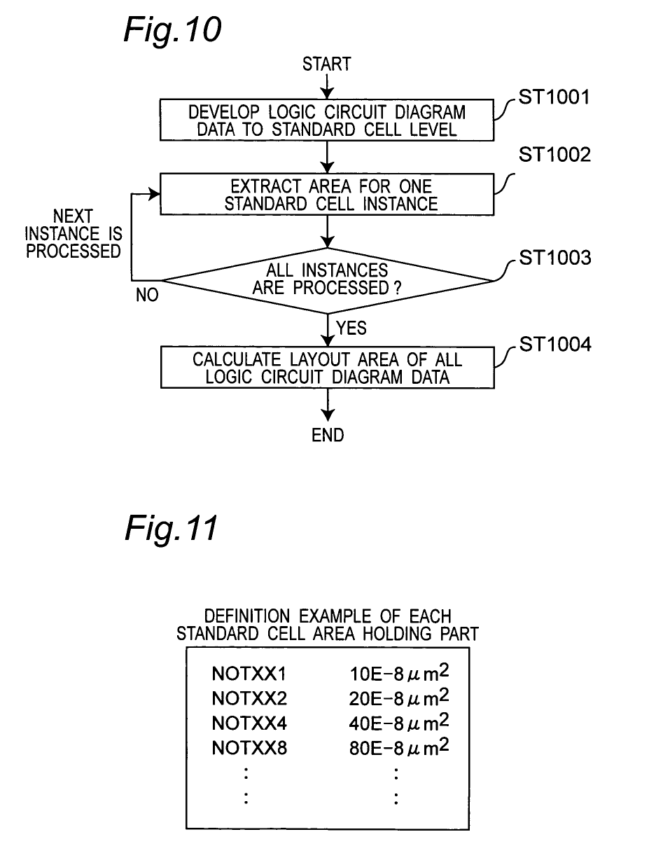

FIG. 10 is a flowchart showing operations of the above-mentioned “logic circuit diagram input device” shown in FIG. 9. The operations will be described in reference to the example shown in FIG. 8. First, the logic circuit diagram information having the hierarchical structure shown in FIG. 8 is read from the “logic circuit diagram information storing part having a hierarchical structure” 9-1, develops it to the standard cell level by the “hierarchy developing means” 9-2 and the developed information of the standard cell instances Inst 11, Inst 12, Inst 13, Inst 21 and Inst 22 is stored in the “standard cell level hierarchy-developed information holding part” 9-3 (step ST1001).

Then, the area value of the Inst 11 among the standard cell instances held in the “standard cell level hierarchy-developed information holding part” 9-3 is searched and extracted from the “each standard cell area holding part” 9-4 and stored in the “instance area holding part” 9-6(ST1002). According to the embodiment 3, assuming that the “each standard cell area holding part” 9-4 is defined as shown in FIG. 11, the area of the Inst 11 which is an instance of a standard cell NOTXX4 is 40E−8 μm². The operation at step ST1002 is performed on all of the remaining instances Inst 12, Inst 13, Inst 21 and Inst 22 (step ST1003).

At last, the estimated layout area: 90E−8 μm² is obtained by adding area values for respective instances Inst 11, Inst 12, Inst 21 and Inst 22 which were stored in the “instance area holding part” 9-6 at steps ST1002 and ST1003 (ST706).

Thus, in the method of designing the standard cell, since not only the area of the cell itself, but also the appropriate layout area according to the arrangement conditions of the cells are obtained, it can be eliminated to be forced to change the design of the logic circuit because of area restriction violation which occurs at the time of designing the layout often.

Embodiment 4

According to an embodiment 4 of the present invention, a description will be made of a “logic circuit diagram input device” which can further precisely estimate a layout area of a “logic circuit diagram constituted by a standard cell” based on the logic circuit diagram by correcting each standard cell area calculated in the embodiment 3 with a predefined “area possession ratio” for each kind of the standard cell.

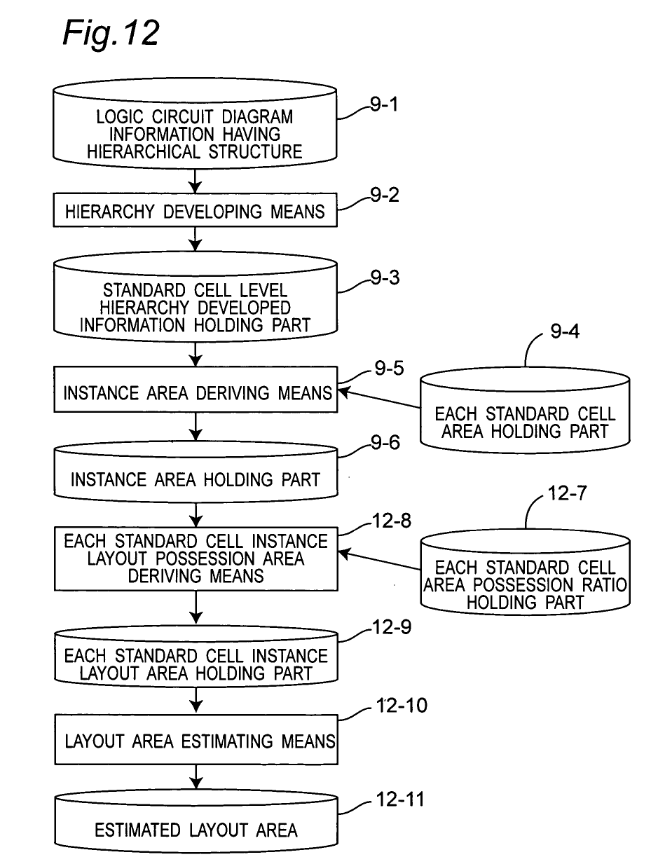

FIG. 12 is a block diagram showing a structure of the “logic circuit diagram input device” according to the embodiment 4 of the present invention. Referring to FIG. 12, blocks 9-1 to 9-6 are the same ones as those to which the same reference numerals are allotted in FIG. 9 in the embodiment 3. An “each standard cell area possession ratio holding part” 12-7 holds an area possession ratio which was predefined for one standard cell.

“Each standard cell instance layout area calculating means” 12-8 divides each of the standard cell instances held in the “instance area holding part” 9-6 by the possession ratio defined in the “each standard cell area possession ratio holding part” 12-7 and finds a layout area of each standard cell instance.

An “each standard cell instance layout area holding part” 12-9 holds the estimated area of the standard cell instance on the layout which is found by the “each standard cell instance layout area calculating means” 12-8. “Layout area estimating means” 12-10 finds an estimated layout area by adding the estimated layout areas of the respective instances which were held in the “each standard cell instance layout area holding part” 12-9 and stores it in an “estimated layout area storing part” 12-11.

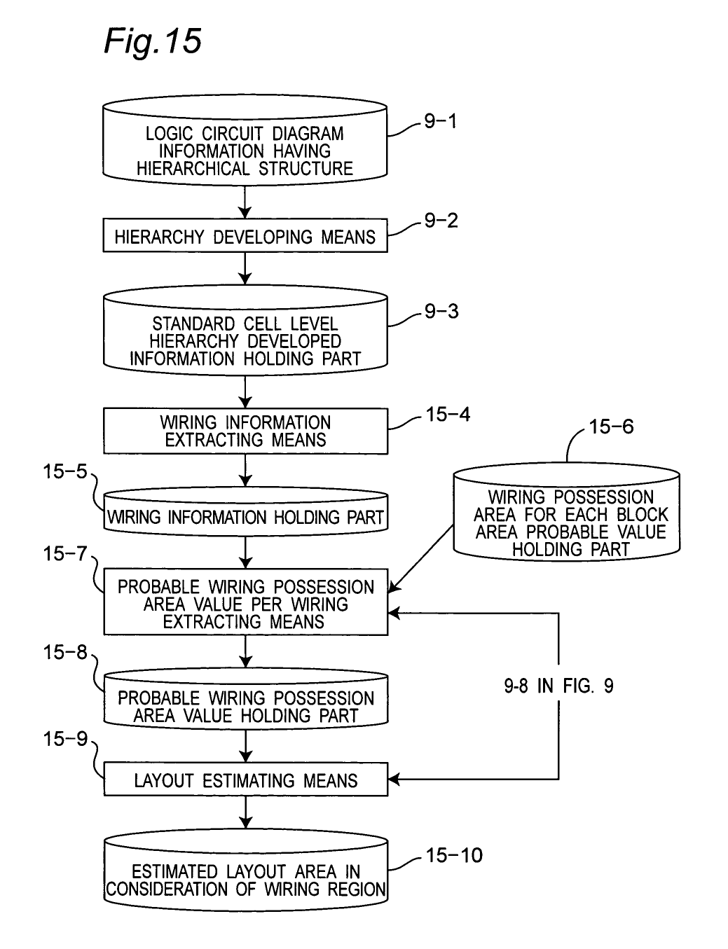

FIG. 14 is a flowchart showing operations of the above-described “logic circuit diagram input device” and the operations will be described in reference to the example shown in FIG. 8. First, at steps ST1001 and ST1002 shown in FIG. 14, the same operations as in the steps ST1001 and ST1002 described in FIG. 10 in the embodiment 3 are performed to obtain an area of Inst 11: 40E−8 μm² and stores it in the “instance area holding part” 9-6.

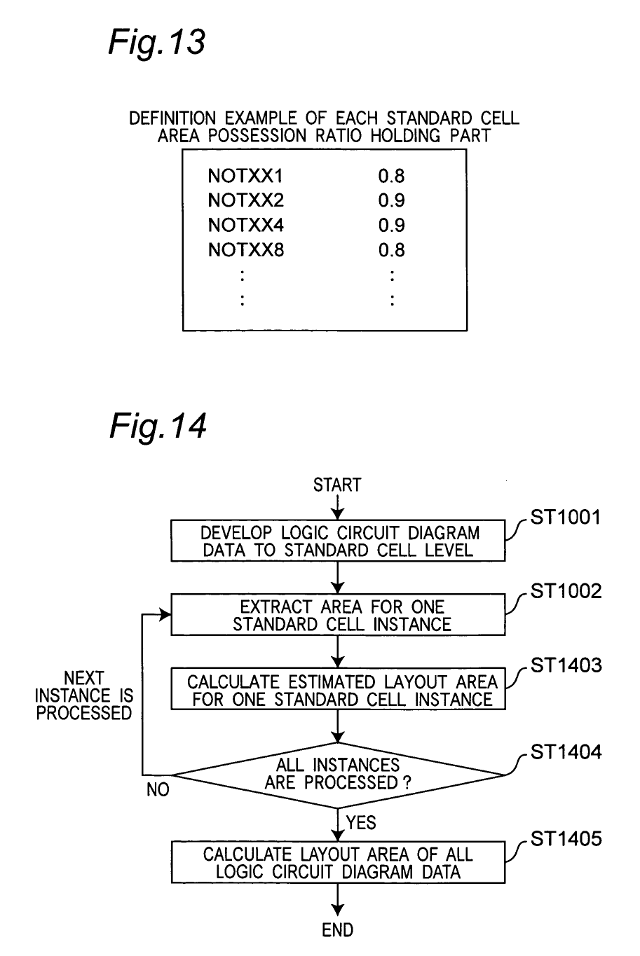

Then, the area possession ratio for each standard cell which is defined in the “each standard cell area possession ratio storing part” 12-7 such as a value 0.8 corresponding to the NOTXX4 shown in FIG. 13 of definition example is extracted and the area of the Inst 11: 40E−8 μm² which was stored in the “instance area holding part” 9-6 is divided by that value to obtain the possession area of Inst 11 on the layout: 50E−8 μm², which is stored in the “each standard cell instance layout area holding part” 12-9 (step ST1403). The operations at steps ST1002 to ST1403 are performed on all of the remaining instances Inst 12, Inst 13, Inst 21 and Inst 22 (step ST1404).

At last, an estimated layout area: 12E−8 μm² is obtained by adding area values for respective instances Inst 11, Inst 12, Inst 13, Inst 21 and Inst 22 stored in the “each standard cell instance area holding part” 12-10 at steps ST1002 to ST1404 (ST1405).

Thus, since the each area of the standard cell is corrected with the area possession ratio for each standard cell, the area after laid out can be further precisely and easily estimated as compared with the embodiment 3 and it can be eliminated to be forced to change the design of the logic circuit because of area restriction violation which occurs at the time of designing the layout often.

Embodiment 5

According to an embodiment 5 of the present invention, a description will be made of a “logic circuit diagram input device” which can easily estimate a layout area of the “logic circuit diagram comprising a standard cell” based on the logic circuit diagram in consideration of a “wiring region” as well.

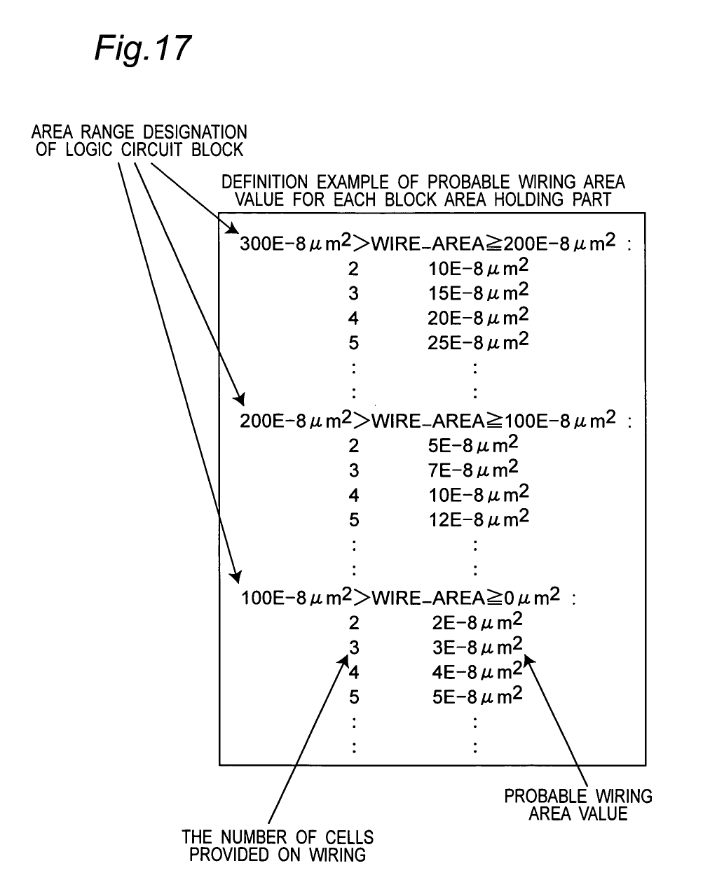

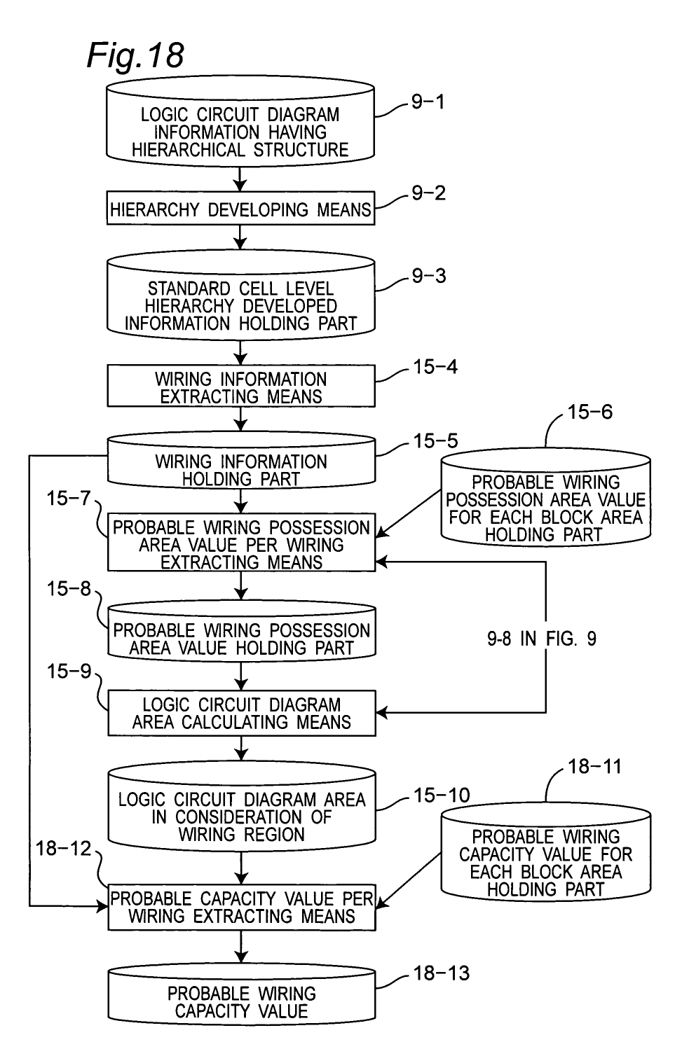

FIG. 15 is a block diagram showing a structure of the “logic circuit diagram input device” according to the embodiment 5 of the present invention. Referring to FIG. 15, blocks 9-1 to 9-3 are the same ones as those to which the same reference numerals are allotted in FIG. 9 in the embodiment 3. “Wiring information extracting means” 15-4 extracts wiring information from a standard cell level developed circuit diagram which was stored in the “standard cell level hierarchy-developed information holding part” 9-3. A “wiring information holding part” 15-5 holds the wiring information. A“wiring possession area for each block area probable value holding part” 15-6 divides an estimated layout area into a plurality of block ranges and holds a probable value of a wiring possession area defined according to the number of cells provided on the wiring for the respective block ranges as shown in FIG. 17.

“Means for extracting a probable value of wiring possession area per wiring” 15-7 selects the block range comprising the “estimated layout area (if this area is not obtained, a default value is used)” and according to each wiring information (the number of cells) stored in the “wiring information holding part” 15-5, the relevant possession area probable value is extracted from the “wiring possession area for each block area probable value holding part” 15-6 within the selected block range. A“probable value of wiring possession area holding part” 15-8 holds the probable value of the wiring possession area per wiring extracted by the “means for extracting a probable value of wiring possession area per wiring” 15-7.

“Layout area estimating means” 15-9 finds a layout area in consideration of a wiring region as well by adding all of the probable value of the wiring possession areas of all wiring held in the “probable value of wiring possession area holding part” 15-8 to the “estimated layout area” found in the “estimated layout area storing part” 9-8 shown in FIG. 9.

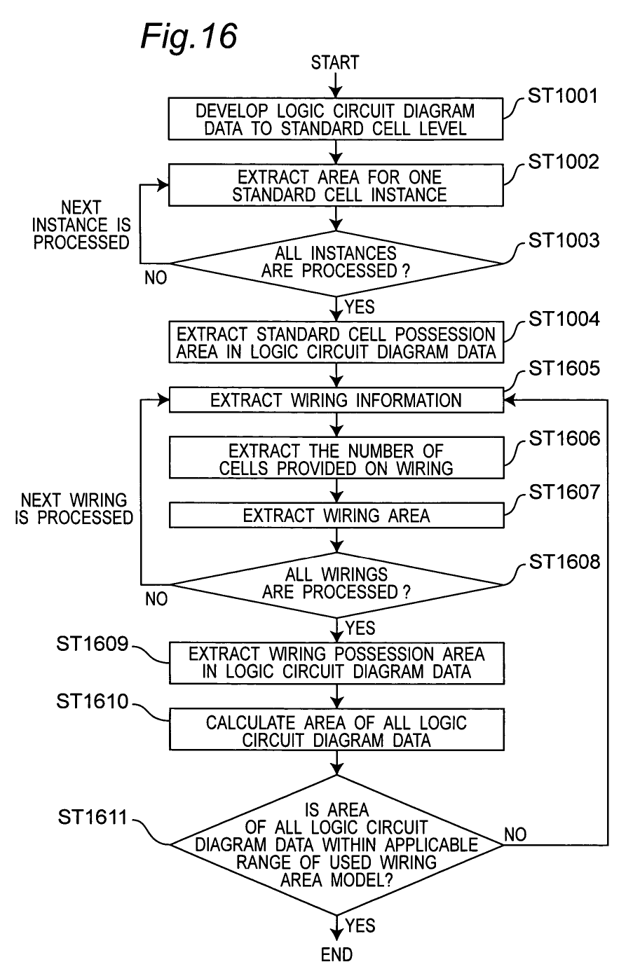

FIG. 16 is a flowchart showing operations of the “logic circuit diagram input device” shown in FIG. 15 and the operations will be described in reference to the example shown in FIG. 8. First, at steps ST1001 to ST1004 shown in FIG. 16, the same operations as at steps ST1001 to ST1004 described in FIG. 10 in the embodiment 3 are performed to obtain an area occupied by the standard cell (in which the wiring region is not considered): 90E−8 μm² in the information stored in the “logic circuit diagram information having a hierarchical structure” 9-1 and stores it in the “estimated layout area storing part” 9-8.

Then, wiring information of NET11 is extracted from the data held in the “standard cell level hierarchy-developed information holding part” 9-3 (ST1605) and the number of cells provided on the wiring is extracted (ST1606). In this case, three standard cells of Inst 11, Inst 12 and Inst 13 are provided on the NET11. As shown in FIG. 17, in the “wiring possession area for each block area probable value holding part” 15-6, probable number of the wiring areas are categorized based on “area ranges of the logical circuit blocks” and defined for each cell provided on the wiring.

Then, referring to FIG. 17, the block range of the maximum “area range of the logic circuit block” area “300E−8 μm²>WIRE_AREA>200E−8 μm²” is firstly selected and the probable value of the wiring area: 15E−8 μm² corresponding to the number of cells (3) extracted at step ST1606 is extracted in the block range (ST1607). The operations at steps ST1605 to ST1607 are performed on all of the remaining wirings NET 1, NET 2, NET 3 and NET 21 and the results are stored in the “probable value of wiring possession area holding part” 15-8 (step ST1608).

Then, the probable area values of the wirings held in the “probable value of wiring possession area holding part” 15-8 are added by the “logic circuit diagram area calculating means” 15-9 to find the “wiring possession area during the layout”: 60E−8 μm² (ST 1609) and that value is added to the “standard cell possession area during the layout”: 90E−8 μm² which was stored in the “estimated layout area storing part” 9-8 at steps ST1001 to ST1004 to calculate an “estimated layout area in consideration of a wiring region”: 150E−8 μm² (step ST1610).

Then, the block range of “200E−8 μm²>WIRE_AREA>100E−8 μm²” is selected as the “area range of a logic circuit block area” shown in FIG. 17 based on the “estimated layout area in consideration of a wiring region”: 150E−8 μm² which was calculated at step ST1610. Then, the probable value of the wiring area: 7E−8 μm² corresponding to the number of cells is extracted from this block range and the area value is corrected by performing the operations at steps ST1605 to ST1610 again. When the area value is converged to a constant value by repeating the above, the estimated value of the optimum “layout area in consideration of the wiring region”: 119E−8 μm² can be obtained according to the information stored in the “logic circuit diagram information storing part having a hierarchical structure” 9-1 (step ST1611).

Thus, since the area after laid out can be easily estimated in consideration of the wiring region at the stage of designing a logic circuit, it is eliminated to be forced to change the design of the logic circuit because of area restriction violation which is generated often at the time of designing the layout.

Embodiment 6

According to an embodiment 6, a description will be made of a “logic circuit diagram input device” which can easily obtain an estimated capacity value for the respective wirings in a “logic circuit diagram constituted by a standard cell”.

FIG. 18 is a block diagram showing a structure of the “logic circuit diagram input device” according to the embodiment 6. Referring to FIG. 18, blocks 9-1 to 9-3 and 15-4 to 15-10 are the same as those to which the same reference numerals are in FIG. 15 allotted according to the embodiment 5.

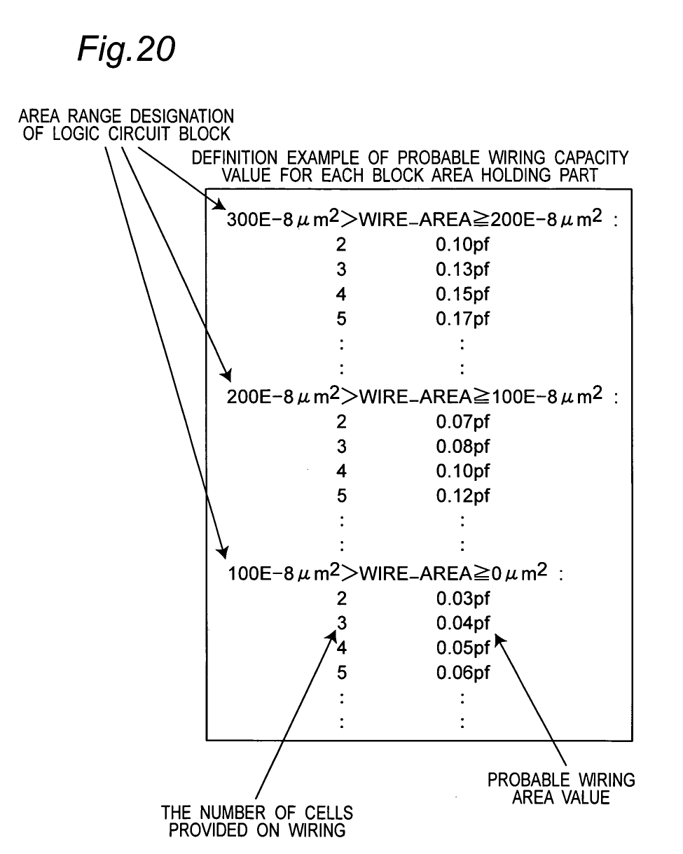

As shown in FIG. 20, an “each block area wiring capacity holding part” 18-11 divides a layout area of the logic circuit diagram into a plurality of block ranges and holds a probable value of the wiring capacity defined according to the number of cells provided on a wiring within the respective block ranges.

“Means for extracting probable value of capacity per wiring” 18-12 selects the “block range” comprising the area value obtained in a “logic circuit diagram area in consideration of a wiring region” 15-10 in the “each block area wiring capacity holding part” 18-11 according to each wiring information (including the number of cells) stored in the “wiring information holding part” 15-5, extracts a relevant capacity value corresponding to the number of cells in the selected “block range” and stores it in a “probable wiring capacity value storing part” 18-13.

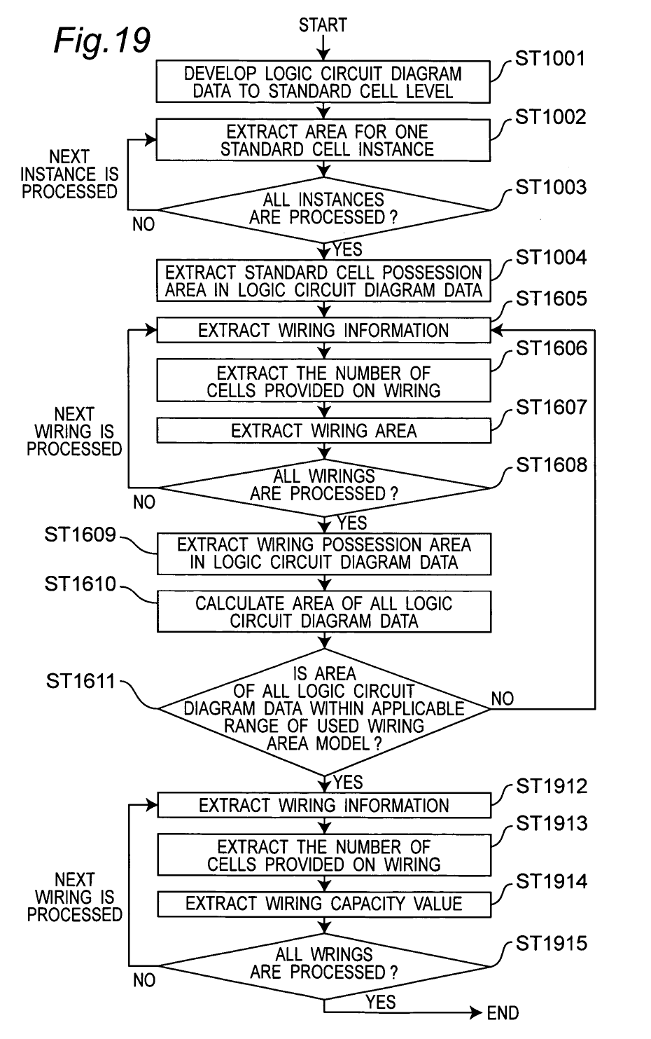

FIG. 19 is a flowchart showing the operations of the “logic circuit diagram input device” having the above-described structure and the operations will be described with reference to the example shown in FIG. 8. First, steps ST1001 to ST1004 and ST1605 to ST1611 in FIG. 19 are the same operations as steps ST1001 to ST1004 and ST1605 to ST1611 described in FIG. 16 according to the embodiment 5, which are performed to calculate the “estimated layout area in consideration of the wiring region”: 19E−8 μm² from the “logic circuit diagram information having the hierarchical structure” in the example shown in FIG. 8 and stores it in the “estimated layout area storing part in consideration of the wiring region” 15-10.

Then, the wiring information of the NET 11 is extracted from the data held in the “standard cell level hierarchy-developed information holding part” 9-3 (ST1912) and the number of standard cells provided on the wiring is extracted (ST1913). In this case, three standard cells of Inst 11, Inst 12 and Inst 13 are provided on the NET 11.

Then, as the “block range” comprising the estimated area value: 119E−8 μm² stored in the “layout area in consideration of a wiring region” 15-10, “200E−8 μm²>WIRE_AREA>100E−8 μm²” is selected and the probable value of the wiring capacity: 0.08 pf corresponding to the number of cells 3: extracted at step ST1913 is extracted from the selected block range (ST1914). The operations from step ST1912 to step ST1914 are repeated to obtain probable capacity values for all of the wiring in the “logic circuit diagram information storing part having a hierarchical structure” 9-1.

As described above, since an approximate value of a wiring capacity can be easily anticipated before the layout, simulation with high precision can be implemented before the design of the layout by adding the approximate value of the wiring capacity to the simulation before the design of the layout.

Embodiment 7

According to an embodiment 7 of the present invention, there is provided a “logic circuit diagram input device” which can reflect the approximate value of the wiring capacity obtained in the embodiment 6 to the information stored in the “logic circuit diagram information storing part having a hierarchical structure” 9-1.

Respective approximate values of the wiring capacities provided according to the embodiment 6 are added to a symbol for a capacity element as property information per wiring and the symbol is inserted into the relevant wiring in the “logic circuit diagram information storing part having a hierarchical structure” 9-1.

Thus, the approximate value of the wiring capacity can be also controlled on the logic circuit diagram information in addition to the circuit connection information, so that the approximate value of the wiring capacity can be easily reflected to the net list for subsequent simulation.

Embodiment 8

According to an embodiment 8 of the present invention, there is provided a “logic circuit diagram input device” which can provide an estimated value of a layout area with higher precision by adding further detailed physical information such as a “maximum gate width”, a “unit resistance value” or a “unit capacity value” other than L, W, AD and AS which are added to the logic circuit diagram as transistor properties in the embodiment 1. It is needless to say that with regard to a part constituted by the standard cell, the layout area can be estimated according to the embodiments 3, 4, 5 and 6.

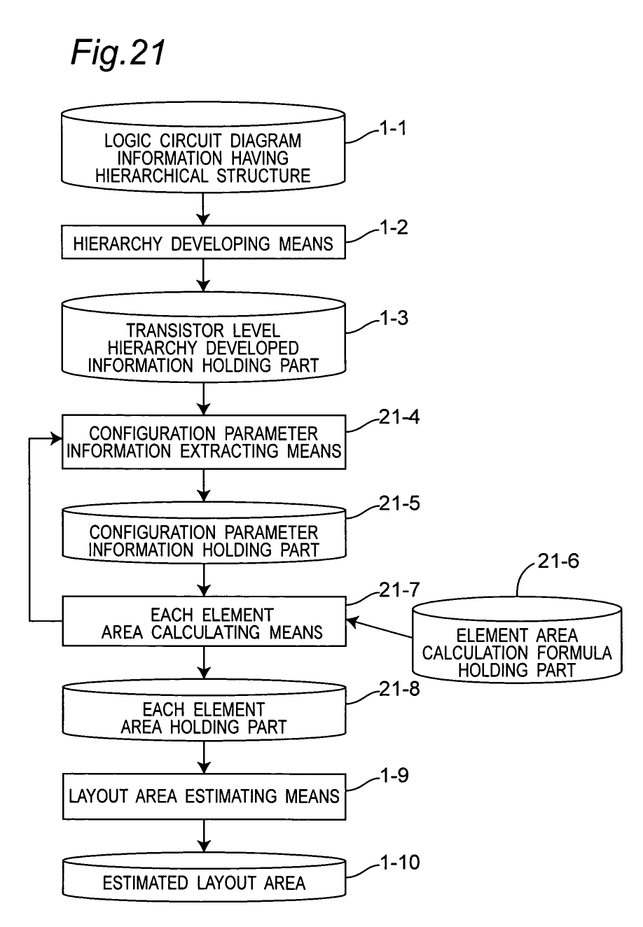

FIG. 21 is a block diagram showing a structure of the “logic circuit diagram input device” according to the embodiment 8. Referring to FIG. 21, blocks 1-1 to 1-3 and 1-9 and 1-10 are the same as those to which the same reference numerals are allotted in FIG. 1 in the embodiment 1. “Configuration parameter information extracting means” 21-4 extracts configuration parameter information which is added as a property from element information such as a transistor, a resistance or the capacity stored in the “transistor level developed information holding part” 1-3.

A “configuration parameter information holding part” 21-5 holds the configuration parameter information of the respective transistor, the resistance and the capacity element which is extracted by the “configuration parameter extracting means” 21-4. An “element area calculation holding part” 21-6 holds area calculation formulas which are defined respective for the transistor, resistance and capacity.

“Each element area calculating means” 21-7 calculates an area for each element from the configuration parameter information for each element held in the “configuration parameter information holding part” 21-5 using calculation formula defined in the “element area calculation formula holding part” 21-6. An “each element area holding part” 21-8 holds areas for the transistor, the resistance and the capacity element, respectively, which are calculated by the “each element area calculating means” 21-7.

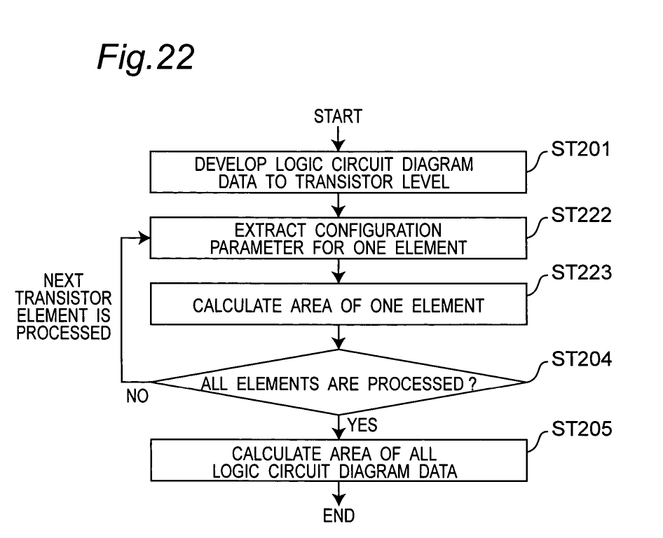

FIG. 22 is a flowchart showing operations of the “logic circuit diagram input device” shown in FIG. 21. Referring to FIG. 22, a logic circuit diagram having a hierarchical structure is developed to a transistor level like the embodiment 1 and the developed information for the transistor, the resistance and the capacity element is stored in the “transistor level hierarchy developed information holding part” 1-3 (step ST1201).

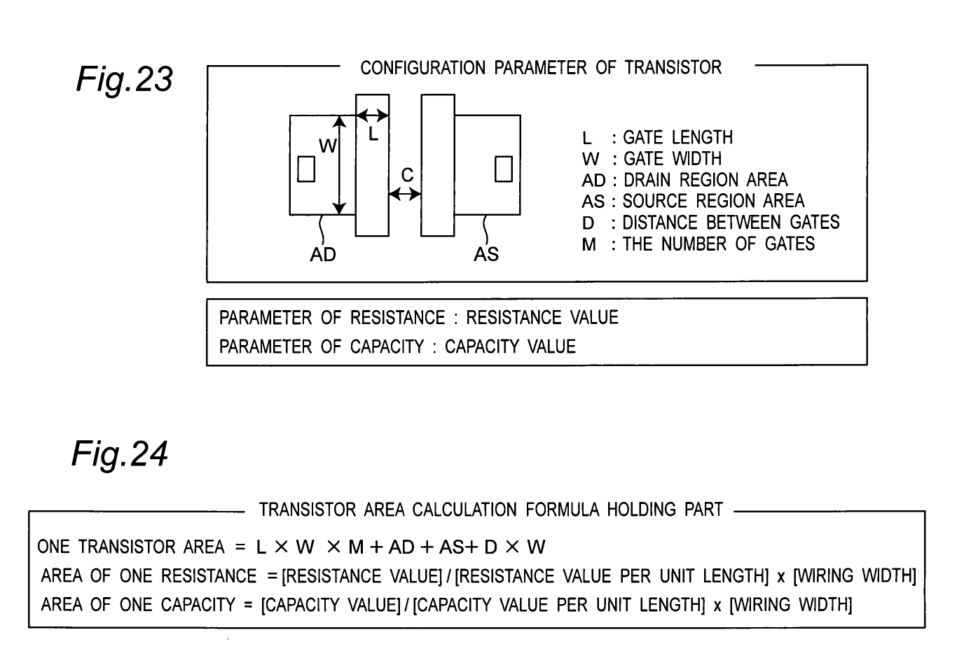

Then, a configuration parameter which is added as a property for the transistor, the resistance and the capacity element, respectively, in the “transistor level hierarchy developed information holding part” 1-3 is extracted and stored in the “configuration parameter information holding part” 22-5 (ST1222). As shown in FIG. 23, the extracted parameter information comprises in case of the transistor, a gate length L, a gate width W, a drain region area AD, a source region area AS, the number of gates, and a distance between gates D, in case of the resistance element, a resistance value, and in case of the capacity element, a capacity value. If the transistor comprises a plurality of gates, there may be different gate widths W in each gates. In this case, the longest width is to be selected.

Then, an area value for each element is calculated using the area calculation formulas (FIG. 24) for the transistor, the resistance and the capacity element, respectively, which are stored in the “element area calculation formula holding part” 21-6 and stored in the “each element area holding part” 21-8 (ST223). Similarly, the operations at steps ST222 and ST223 are performed on the remaining elements (ST204). Then, finally, at steps ST222 to ST204, the element area values stored in the “each element area holding part” 21-8 are added together and the result is stored in the “estimated layout area storing part” 1-10.

Thus, the layout area is further precisely estimated as compared with the “logic circuit diagram input device” in the embodiments 1 and 2 of the present invention and it can be eliminated to be forced to change the design of the logic circuit because of area restriction violation which is often generated the layout.

Embodiment 9

According to an embodiment 9 of the present invention, a description will be made of a “logic circuit diagram input device” which can estimate an area with high precision by applying a possession ratio to every block having a different function. This embodiment is different from the embodiments 2, 3 and 4, in that the area possession ratio is applied not only to each element such as transistor and each kind of the standard cell but also to higher rank of block. In addition this embodiment is different from the embodiment 6 in that the possession ratio is applied to each block in consideration of the characteristic of the block while the wiring area of the block is estimated from the FanOut number (the number of connection) of each standard cell according to the embodiment 6.

More specifically, in case of a DRAM memory, each function is divided into a memory-cell part, a pad part, a direct peripheral part such as a sense amplifier, a control system part and the like and an element size, a configuration and a degree of layout concentration used in each function are different. When the area is estimated, each part of them is regarded as one block and an appropriate area possession ratio is applied to it in consideration of the characteristic of each block, whereby the area can be estimated with higher precision.

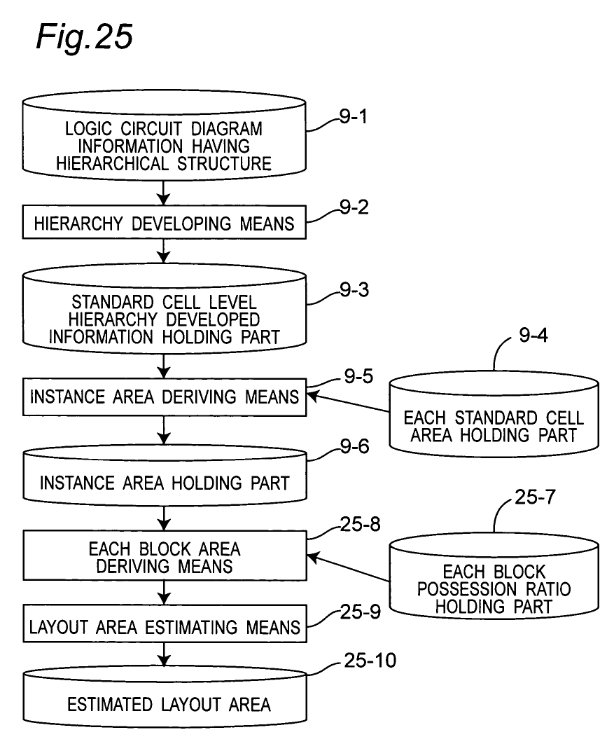

FIG. 25 is a block diagram showing a structure of the “logic circuit diagram input device” according to the embodiment 9. Referring to FIG. 25, blocks 9-1 to 9-6 are the same functions as those to which the same reference numerals are allotted in FIG. 9 according to the embodiment 3. An “each block possession ratio holding part” 25-7 holds a possession ratio which was defined each block and the possession ratio may be applied as a file or directly applied by a user using a GUI. “Each block area finding means” 25-8 calculate a sum of areas of instances belonging to each block using each instance area value held in the “instance area holding part” 9-6 and calculates an estimated area value in consideration of the possession ratio and it is stored in a “estimated layout area storing part” 25-10.

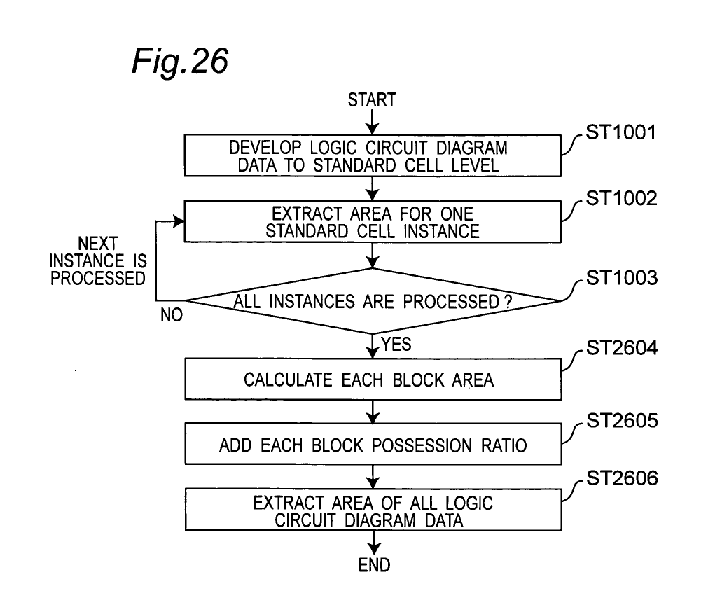

FIG. 26 is a flowchart showing operations of the “logic circuit diagram input device” shown in FIG. 25. The steps ST1001 to ST1003 are the same operations as those in FIG. 10. In each block defined in the “each block possession ratio holding part” 25-7, areas of instances belonging to the relevant block are added together and an area of the block is calculated (ST2604). The block comprising the relevant instances can be easily distinguished since the instance name of the block that belongs to the instance name is added at the time of development of the hierarchy. In addition, the area of each block is estimated using the possession ratio defined in an “each block possession ratio holding part” 25-7 (ST2605).

At last, areas of all blocks calculated at the previous steps are added together to obtain the estimated layout area for the logic circuit diagram. Thus, the layout area can be estimated with high precision in consideration of the characteristics of the blocks and it can be eliminated to be formed to change the design of the logic circuit diagram because of restriction violation generated after the design of the layout.

Embodiment 10

According to an embodiment 10 of the present invention, there is provided a “logic circuit diagram input device” provided with a function which transfers estimated each cell, a block area and the number of basic cells (BC) to a layout designing apparatus as an input file in addition to the function of estimating the layout area according to the embodiments 1 to 6 and the embodiments 8 and 9.

According to this logic circuit diagram input device, a designer for a layout can design the layout according to a targeted area at the time of designing the layout and when there is a large difference between the layout area and the targeted area, the designer can immediately feed it back to a designer of the logic circuit.

Embodiment 11

According to an embodiment 11 of the present invention, there is provided a “logic circuit diagram input device” provided with a function which stores an estimated each cell, a block area and the number of basic cells (BC) in each instance element on the logic circuit diagram as a property in addition to the function of estimating the layout area according to the embodiments 1 to 6 and the embodiments 8 and 9.

According to the logic circuit diagram input device, once the area is estimated, it is all right only an area of a changed cell is estimated as long as a logic is not changed, whereby reduces operation time.

According to the present invention, since the area after layout can be easily estimated based on the logic circuit diagram, it can be eliminated to be formed to change the design of the logic circuit diagram because of restriction violation that is often generated at the time of layout designing. Furthermore, since a hierarchical relation of a transistor or each property can be automatically read from the information of the logic circuit diagram, working efficiency can be improved.

What is claimed is:

1. A logic circuit diagram input device for estimating a layout area based on a logic circuit diagram constituted by a transistor as a minimum unit, comprising:
hierarchy developing means for developing logic circuit diagram information having a hierarchical structure to information at a transistor level;
configuration parameter information extracting means for extracting configuration parameter information such as a gate length, a gate width, a drain region area and a source region area which are added to each transistor as a property;
area calculating means for calculating each transistor area using a transistor area calculation formula for calculating a transistor area from the said configuration parameter information; and
layout area estimating means for estimating a layout area by adding all areas of the transistors together.

2. A logic circuit diagram input device according to claim 1, wherein said each transistor area is corrected using an area possession ratio per predefined transistor.

3. A logic circuit diagram input device for estimating a layout area based on a logic circuit diagram constituted by a standard cell, comprising:
hierarchy developing means for developing logic circuit diagram information having a hierarchical structure to information at a standard cell level;
an each standard cell area holding part for holding each standard cell area according to an instance;
area deriving means for deriving said developed each standard cell area according to the instance of the cell based on data of said each standard cell area holding part; and
layout area estimating means for estimating the layout area by adding all of the areas of the standard cells.

4. A logic circuit diagram input device according to claim 3, wherein said each standard cell area is corrected using an area possession ratio defined for each kind of the standard cell.

5. A logic circuit diagram input device according to claim 3, comprising:
wiring information extracting means for extracting wiring information from said logic circuit diagram information having the hierarchical structure; and
probable wiring possession area value holding means for holding a probable value of a wiring possession area, which is defined according to a layout area and the number of cells, wherein the sum of the probable values of the wiring possession areas which were extracted from the probable wiring possession area value holding means per wiring is added to said layout area.

6. A logic circuit diagram input device according to claim 5, comprising:
each block area wiring capacity of holding part for holding a probable wiring capacity value defined according to a layout area and the number of cells; and
probable wiring capacity value extracting means for extracting probable wiring capacity value from said each block area wiring capacity holding part per wiring.

7. A logic circuit diagram input device according to claim 6, wherein information of said probable wiring capacity value is added to wiring data on the logic circuit diagram constituted by a standard cell as a property or an element.

8. A logic circuit diagram input device according to claim 1, wherein further detailed physical information such as a maximum gate width, a unit resistance value, a unit capacity value or the like is added other than configuration parameter such as a gate length, a gate width, a drain region area and source region area which were added to a transistor element as a property.

9. A logic circuit diagram input device according to claim 2, wherein an area possession ratio is set on higher level of block in stead of an area possession ratio set per transistor.

10. A logic circuit diagram input device according to claim 1, wherein each cell, a block area and the number of basic cells (BC) which were estimated by the device are provided to a layout designing apparatus as an input file.

11. A logic circuit diagram input device according to claim 1, wherein each cell, a block area and the number of basic cells (BC) which were estimated by the device are stored in each instance element on a logic circuit diagram as a property.
